(19) United States
(12) Patent Application Publication
(10) Pub. No.: US 2005/0133522 A1
(43) Pub. Date: Jun. 23, 2005

(54) Handle for cookware

(76) Inventor: Jae Bong Son, Daegu (KR)

Correspondence Address: JACOBSON HOLMAN PLLC, 400 SEVENTH STREET N.W., SUITE 600, WASHINGTON, DC, 20004, US

(21) Appl. No.: 10/843,582

(22) Filed: May 12, 2004

(30) Foreign Application Priority Data
Dec. 22, 2003 (KR) 10-2003-94552

(51) Int. Cl. H01R 11/00

(52) U.S. Cl. 220/759

(57) ABSTRACT

A handle for cookware, which includes a temperature indicator to display temperature variations, is disclosed. The handle includes a mount part joined to a cookware and having a threaded hole, a grip part coupled to the mount part by a rod bolt that passes through the grip part and is screwed into the threaded hole of the mount part, and a connector part detachably coupled between the mount part and the grip part. The connector part includes a thermal conductor fitted in a fitting recess of the connector part and connected to the mount part. The thermal conductor has a thermochromic film or layer that changes in color at a predetermined temperature or higher.

### BACKGROUND OF THE INVENTION

1. Field of the Invention

The present invention relates to a handle for cookware, and more particularly to a handle for cookware, which includes a connector part detachably coupled to a connecting end of the handle and having a temperature indicator to display temperature variations by change of color.

2. Description of the Prior Art

Korean Utility Model Application No. 2003-10128, which is previously filed by the present inventor, discloses a cookware having a thermochromic film coated on an outer surface thereof, which changes in color at a predetermined temperature or higher. FIGS. 1 and 2 show the cookware disclosed in the above Application No. 2003-10128. As shown in FIGS. 1 and 2, the cookware 10 is provided with a thermochromic film 11 attached to its outer surface, which changes in color according to temperature variations. An outer surface of the film 11 is provided with a coating layer 12 of transparent heat-resisting paint.

However, in the cookware disclosed in the Application, since the thermochromic film 11 is attached to the outer surface of the cookware and the heat-resisting is painted thereon, it is inconvenient to monitor the thermochromic film 20, the need for the products is reduced, and the thermochromic film is polluted over time.

### SUMMARY OF THE INVENTION

Accordingly, the present invention has been made keeping in mind the above problems occurring in the prior art, and an object of the present invention is to provide a handle for cookware which includes a temperature indicator easily installed thereto to improve appearance and competitiveness of the products.

In order to accomplish the above object, the present invention provides a handle for cookware, which includes a mount part joined to an outer surface of a cookware and having a threaded hole, a grip part coupled to a rear end of the mount part by a rod bolt that passes through the grip part and is engaged with the threaded hole of the mount part, and a connector part detachably coupled between the mount part (20) and the grip part.

The connector part may include a plane region at its upper surface, at which a fitting recess is formed.

The connector part may include a thermal conductor fitted in the fitting recess of the connector part and connected to the mount part.

The thermal conductor may be provided with a thermochromic film or layer that changes in color at a predetermined temperature or higher.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a conventional cookware to which a temperature indicator is attached;

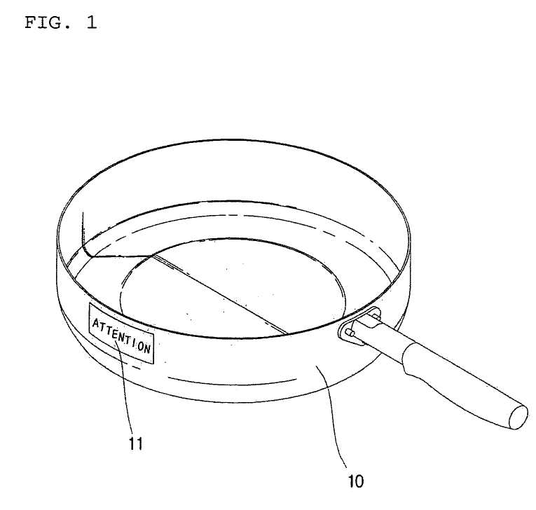

FIG. 2 is a cross-sectional view of a substantial part of the cookware in FIG. 1;

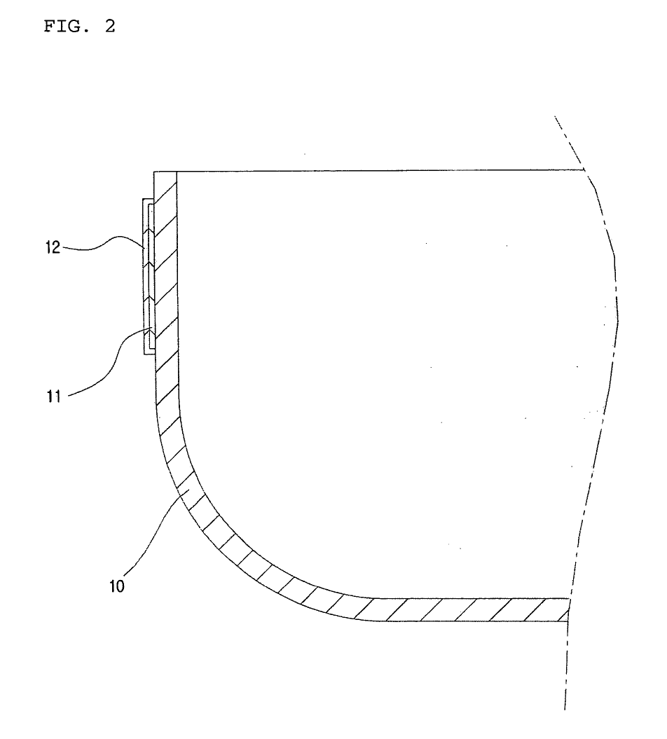

FIG. 3 is a perspective view of a handle for cookware according to the present invention, which is joined to a cookware;

FIG. 4 is a perspective view of the handle for cookware according to the present invention, which is separated from the cookware;

FIG. 5 is an exploded perspective view of the handle shown in FIG. 4; and

FIG. 6 is a cross-sectional view of the handle shown in FIG. 4.

### DETAILED DESCRIPTION OF THE INVENTION

This invention will be described in further detail by way of example with reference to the accompanying drawings.

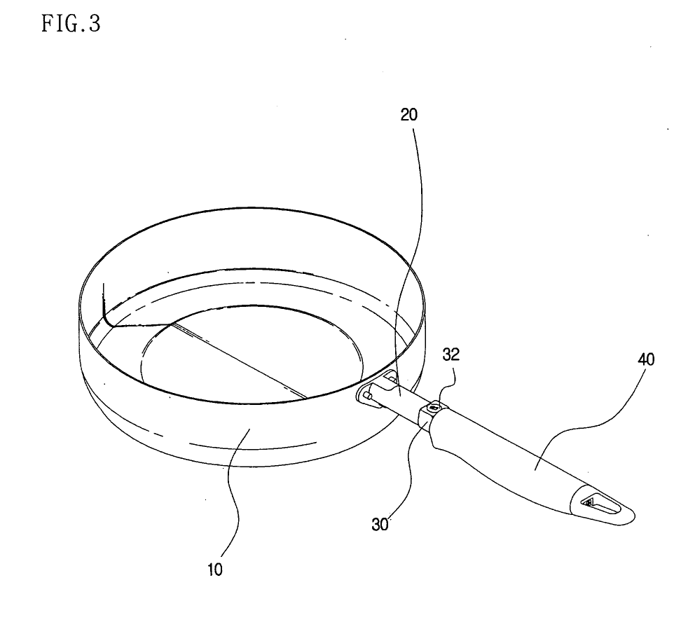

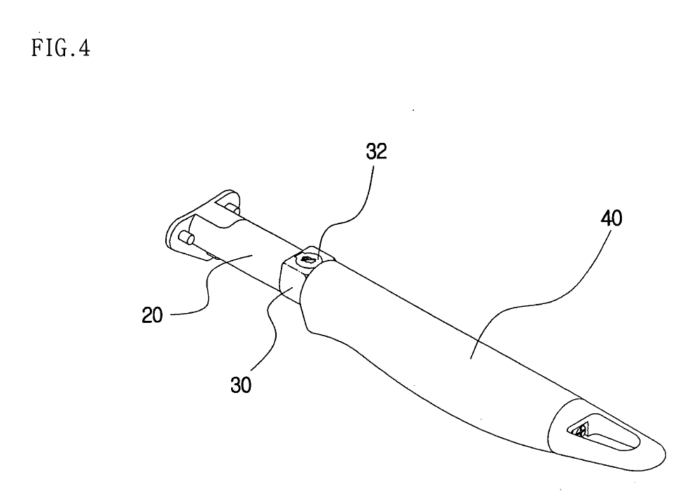

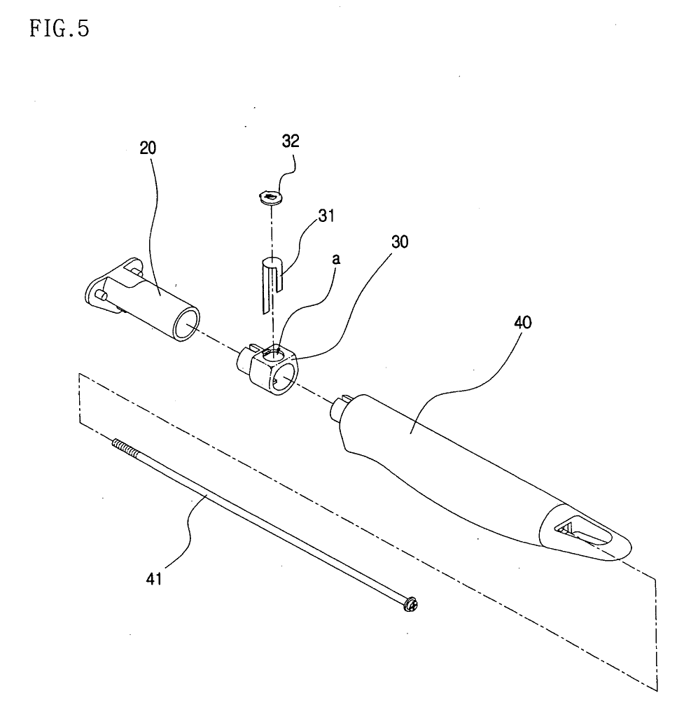

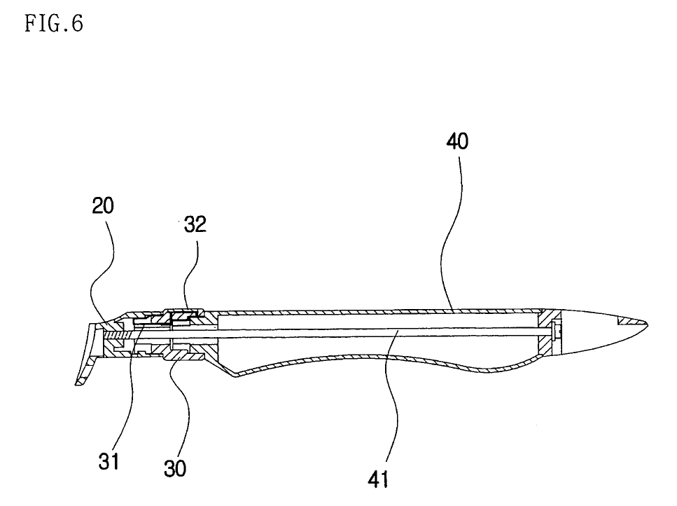

FIGS. 3 through 6 show a handle for cookware according to the present invention. As shown in the drawings, the handle for cookware according to the present invention is comprised of a mount part 20 joined to cookware 10 which opens upward, a connector part 30 disposed behind the mount part 20, and a grip part 40 coupled to the mount part 20 with the connector part 30 interposed therebetween. The mount part 20 is made of aluminum, and has a flange at its front end to enable the handle to be joined to a cookware 10 by rivets. The mount member 20 is provided at its front portion with an inner threaded hole and is provided at its rear portion with a larger insert hole. The connector part 30 is inserted at its front end into the rear insert hole of the mount part 20 and includes an insert hole at its rear end. The connector part 30 is provided at its upper surface with a plane region, on which a fitting recess “a” is formed. The grip part 40 is inserted at its front end into the rear insert hole of the connector part 30 and includes an axial through-hole therein. A rod bolt 41, which has an outer threaded portion at its front end, passes through the through-hole of the grip part 40, and then the front threaded end of the rod bolt 41 is screwed into the inner threaded hole of the mount part 20.

The front end of the connector part 30 is formed to have the same shape as that of the front end of the grip part 40, and the rear end of the connector part 30 is formed to have the same shape as that of the rear end of the mount member 20. Accordingly, the mount part 20 and the grip part 40 can be manufactured by existing molds without a need to use additional molds.

The components of the handle for cookware according to the present invention is firmly assembled in such a way that the rod bolt 41 passes through the through-hole of the grip part 40 from the rear end of the grip part 40 and the threaded front end of the rod bolt 41 is screwed into the threaded hole of the mount part 20 joined to the cookware 10.

The connector part 30 is provided at its plane region with the fitting recess “a”, which communicates with the center hole of the connector part 30. An extension hole is formed at the fitting recess “a” and is extended into the connector part 30. A thermal conductor 31, such as a copper plate, is fitted into the fitting recess “a”, and an end of the thermal conductor 31 is extended into the mount part 20 through the extension hole of the connector part 30. The end of the thermal conductor 31, which is extended into the mount part 20, is coupled to the mount part 20. The thermal conductor 31 is provided at its top plane with a thermochromic layer 32, which is made of a thermochromic film or thermochromic paint that changes color at a predetermined temperature or higher.

With the aid of the thermochromic layer 32 provided on the connector part 30, a user can easily monitor the changes in temperature of the cookware. More specifically, since the thermal conductor 31, such as a copper plate having a high thermal conductivity, is connected to the cookware 10 through the mount part 20 as the cookware 10 is heated, the thermal conductor 31, which is thermally connected to the cookware 10, is also heated. As a result of the rise in temperature of the thermal conductor 31, a color of the thermochromic layer 32 attached to the thermal conductor 31 changes at a predetermined temperature or higher.

According to the present invention, a connector part is interposed between an existing mount part and an existing grip part in the same coupling manner. Accordingly, the present invention can be easily applied to an existing handle for cookware without modification of the handle. Since the connector part is provided with a thermochromic layer or a certain label that is exposed at its upper surface, contamination of the thermochromic layer is prevented and attractiveness in appearance is enhanced.

As described above, the present invention provides a handle for cookware with a connector part, which is easily applied to an existing handle for cookware and allows components of the handle to be easily assembled. In addition, the connector part includes a thermochromic layer connected to the cookware, thereby allowing a user to monitor temperature change of the cookware. Accordingly, the handle for cookware according to the present invention contributes to an improvement in practicability and competitiveness of the products.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A handle for cookware, comprising:
a mount part joined to an outer surface of a cookware and having a threaded hole;
a grip part coupled to a rear end of the mount part by a rod bolt that passes through the grip part and is engaged with the threaded hole of the mount part; and
a connector part detachably coupled between the mount part and the grip part.

2. The handle for cookware as set forth in claim 1, wherein the connector part includes a plane region at its upper surface, at which a fitting recess is formed.

3. The handle for cookware as set forth in claim 2, wherein the connector part includes a thermal conductor fitted in the fitting recess of the connector part and connected to the mount part.

4. The handle for cookware as set forth in claim 3, wherein the thermal conductor is provided with a thermochromic film or layer that changes in color at a predetermined temperature or higher.
